(19) United States
(12) Patent Application Publication
(10) Pub. No.: US 2026/0346450 A1
(43) Pub. Date: Nov. 5, 2026

(54) ROBOTIC VISUAL TACTILE SURFACE INSPECTION SYSTEM

(71) Applicant: Siemens Corporation, Washington, DC (US)

(72) Inventors: Chengtao Wen, Redwood City, CA (US); Justinian Rosca, Princeton, NJ (US); Eugen Solowjow, Berkeley, CA (US); Gokul Narayanan Sathya Narayanan, Emeryville, CA (US); Jose Luis Susa Rincon, Merced, CA (US); Abhiroop Ajith, Emeryville, CA (US)

(73) Assignee: Siemens Corporation, Washington, DC (US)

(21) Appl. No.: 19/158,987

(22) PCT Filed: Aug. 29, 2023
(86) PCT No.: PCT/US2023/031324

§ 371 Date: Aug. 22, 2025

Related U.S. Application Data
(60) Provisional application No. 63/487,623, filed on Mar. 1, 2023.

(51) Int. Cl. B25J 9/16; B25J 13/08; G06T 7/00; G06T 7/11; G06T 7/194

(52) U.S. Cl. CPC B25J 9/1679; B25J 9/1697; B25J 13/084; G06T 7/0004; G06T 7/11; G06T 7/194; G06T 2200/04; G06T 2207/10024; G06T 2207/10028; G06T 2207/30108

(57) ABSTRACT

A robotic visual and tactile inspection system can perform surface inspection to identify different defects on various large industrial components (e.g., different sizes, geometries, smoothness, textures, etc.) that are used in various industries (e.g., manufacturing, transportation, aerospace, defense, power, process industries, etc.). The system can conduct a visual inspection using a RGBD camera to detect defect areas. A vision and tactile guided robot control system can be configured to control a robot to perform a tactile inspection, thereby detecting and identifying various defects as well as various attributes of the defects in various surfaces.

### GOVERNMENT RIGHTS

This invention was made with US government support under W911NF-17-3-0004 awarded by Advanced Robotics for Manufacturing Institute (ARM). The US government has certain rights in this invention.

### BACKGROUND

Quality inspection and control is essential for various manufacturing industries to ensure safe operations and prevent catastrophic failures. Furthermore, quality inspection and control can reduce waste of resources, increase efficiency and profits, and improve customer satisfaction by consistently delivering quality products. Further still, in various industries, materials and components are subjected to strict quality control standards for both dimensions and surface imperfections. In some cases, quality control processes can be crucially important for components under extreme operating conditions to prevent catastrophic loss due to component failure (e.g., metal fatigue failure).

Today's quality inspection processes are often implemented through manual labor of highly trained quality inspectors and engineers with knowledge of the component and material properties. It is recognized herein that current approaches to quality inspection (e.g., manual inspection) are often slow, error prone, and inconsistent.

### BRIEF SUMMARY

Embodiments of the invention address and overcome one or more of the described-herein shortcomings or technical problems by providing methods, systems, and apparatuses for perform automatic and digital quality inspection of various materials or components, to improve efficiency, productivity, performance, and the like. In an example, a robotic visual tactile inspection system can perform surface inspection to identify different defects on various large industrial components (e.g., different sizes, geometries, smoothness, textures, etc.) that are used in various industries (e.g., manufacturing, transportation, aerospace, defense, power, process industries, etc.).

In an example aspect, a vision and tactile guided robot system can include a robot defining a tactile sensor configured to contact and capture tactile images of a surface of a component. The system can further include a red green blue depth (RGBD) camera configured to capture images of the surface of the component. The system can also include one or more processors, and a memory storing instructions that, when executed by the one or more processors, cause the robot system to perform various operations. The operations can include controlling the tactile sensor so as to perform a tactile inspection of the surface, based at least in part on an RBGD image captured by the RGBD camera.

Based on the RBGD image, the system can determine a region of interest representative of an area on the surface in which a defect is defined. The system can capture a first image, with the tactile sensor, of the surface within the region of interest. The system can move the tactile sensor toward the area on the surface. The system can capture a second image, with the tactile sensor, of the surface within the region of interest. The system can generate a first foreground mask from the first image and the second image. Based on the first foreground mask, the system can determine whether the defect is greater than a predetermined threshold. When the defect is greater than the predetermined threshold, the system can stop the robot from moving further and capture two-dimensional (2D) images of the defect with the tactile sensor. Based on the 2D images, the system can reconstruct a three-dimensional (3D) image of the defect. Based on the 3D image of the defect, the system can determine one or more attributes corresponding to the defect.

In an example aspect, when the defect is less than the predetermined threshold, the system can move the tactile sensor to a next intermediate point. At the next intermediate point, the system can capture a third image, with the tactile sensor of the surface within the region of interest. The system can generate a second foreground mask from the first image and the third image. Based on the second foreground mask, the system can determine whether the defect is greater than the predetermined threshold. Thus, the system can continue to capture images at different points, with the tactile sensor, until the defect is greater than the predetermined threshold. In another example aspect, based on the RBGD image, the system can determine a normal direction relative to the surface. The system can move the tactile sensor along the normal direction until it contacts the surface.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an example computerized and integrated vision and tactile robotic system configured to perform inspection and defect detection operations on surfaces of various components or parts, in accordance with an example embodiment.

FIG. 2 illustrates an example neural network model that can included in the system shown in FIG. 1 for identifying defects on the surfaces.

FIG. 3 is a flow diagram that illustrates example operations that can be performed by the integrated and tactile robotic system, in accordance with an example embodiment.

FIG. 4 illustrates an example of images that captured and process during the operations shown in FIG. 3.

FIG. 5 illustrates a computing environment within which embodiments of the disclosure may be implemented.

### DETAILED DESCRIPTION

By way of background, human vision inspection can rely on the aided and unaided eye for inspecting a part or component. A commercial airplane fuselage surface is often used herein as an example component or part that is inspected during a tactile inspection, but it will be understood that a surface of any part of component can be inspected in accordance with various embodiments described herein, and all such parts or components are contemplated as being within the scope of this disclosure. Furthermore, as used herein, tactile inspection generally refers to detecting various defects of a particular component, such as distortion in shape, unevenness of a given surface, discontinuities in size, or the like. In some cases, human vision inspection can be augmented by computer vision inspection. For example, industrial cameras coupled to machine vision technology might detect some visual defects. It is recognized herein, however, that such detection techniques might be limited to large flaws on a given surface, and such visual detections are often sensitive to surface reflections and ambient lighting conditions. For example, some minute irregularities, for instance discontinuities on the order of one or more micrometers, might not be visible to the human eye or industrial camera.

In an example, a handheld measurement probe can be manually operated by a human operator, and can be used in combination with visual inspection. Such handheld measurement probes typically define a relatively small field of view, and therefore a trained operator might first identify possible defects visually, and then use the probe to quantify (e.g., length, depth, volume, etc.) the identified possible defects. For example, an example GelSight measurement probe can define a 17 mm×14 mm field of view that is capable of measuring surface defects below 10 microns in various directions. Such level of resolution can assess scratches and pits on industrial parts or components, but the limited field of view might require that a human first identify the defects. It is recognized herein that such manual inspections can be slow and error prone.

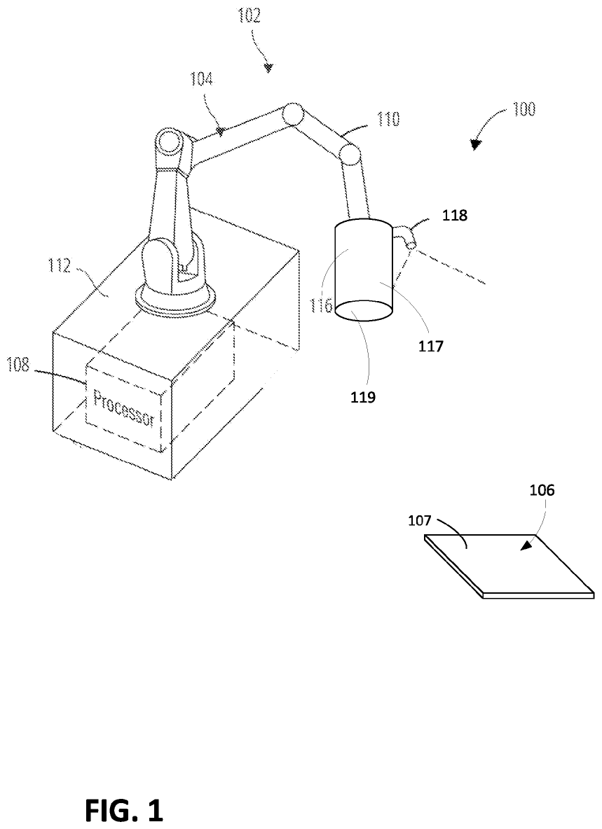

Referring initially to FIG. 1, an example industrial or physical environment or workspace or scene 100 is shown. As used herein, a physical environment, workspace, or scene can refer to any industrial environment. Unless otherwise specified, physical environment, workspace, and scene can be used interchangeably herein, without limitation. For purposes of example, an industrial part or component 106 can be disposed within the environment 100. The component 106 might be, for example and without limitation, part of an airplane fuselage, nozzles of rocket engines, a turbine blade, a bullet casing, auto parts, or 3D printed parts. It will be further understood that the component 106 is presented as an example, such that components referred to herein can be alternatively shaped or define alternative structures, and all such components are contemplated as being within the scope of this disclosure.

The physical environment 100 can include a computerized and integrated vision and tactile robotic system 102 configured to perform inspection and defect detection operations. The robotic system 102 can include one or more robot devices, for instance a robot 104, configured to perform tactile and visual inspections. The system 102 can include one or more computing processors configured to process information and control operations of the system 102, in particular the robot 104. The robot 104 can include one or more processors, for instance a processor 108, configured to process information and/or control various operations associated with the robot 104. A system for operating a machine within a physical environment can further include a memory for storing modules. The processors can further be configured to execute the modules so as to process information and generate models based on the information. It will be understood that the illustrated environment 100 and the system 102 are simplified for purposes of example. The environment 100 and the system 102 may vary as desired, and all such systems and environments are contemplated as being within the scope of this disclosure.

Still referring to FIG. 1, the robot 104 can further include a robotic arm or manipulator 110 and a base 112 configured to support the robotic manipulator 110. The robot 104 can further include an end effector 116 attached to the robotic manipulator 110. The end effector 116 can define a tactile measurement probe or tactile sensor 117, for instance a GelSight probe. The robotic manipulator 110 can be configured to move so as to change the position of the probe 117, for example, so as to move over the component 117 within the physical environment 100. The system 102 can further include one or more cameras or sensors 118, for instance a depth camera or three-dimensional (3D) point cloud camera, configured to detect or record components 106 within the physical environment 100. Alternatively, or additionally, the one or more cameras of the system 102 can include one or more standard two-dimensional (2D) cameras that can record or capture images (e.g., RGB images or depth images) from different viewpoints. Those images can be used to construct 3D images. For example, a 2D camera can be mounted to the robotic manipulator 110 so as to capture images from perspectives along a given trajectory defined by the manipulator 110.

With continuing reference to FIG. 1, the camera 118 can define an RGBD camera configured to coordinate with the tactile sensor 117. The component 106 can define a surface 107 positioned to face the camera 118 and the tactile sensor 117. In particular, the tactile sensor 117 can define an end 119 that can define an elastomer piece or surface (e.g., rubber) configured to contact the surface 107. The tactile sensor 117 can further include an embedded camera configured to capture images of the deformation of the elastomer surface, such than a high resolution 3D geometry of the contact surface 107 can be reconstructed from the camera images. Thus, the robot 104 with the tactile sensor 117 can capture a detailed shape and texture of the component 106 being touched by the end 119, which can enable the system 102 to sense multiple physical properties of the components 106. In an example, the robot 104, in particular the robotic arm 110, moves the RGBD camera 118 so that it traverses the surface 107 and captures images of the surface 107, so as to define a visual inspection. During the visual inspection, based on the captured images of the surface 107, the system 102 can identify defective areas of the surface 107. Based on the identified areas, the robot 104, in particular the arm 110, can move the tactile sensor 117 to contact the identified defective areas on the surface 107 of the component 106 so that the system 102 can detect the type of defect associated with the respective identified defect areas. Examples of defect types include, without limitation, a scratch, dent, pit, gouge, drill run, or the like.

The tactile sensor 117 can detect types and locations of various defects. The tactile sensor 117 can also measure surface defects, for instance the maximum depth and lengths of surface defects below 10 microns in all directions, without being influenced by the reflectivity of the surface. In an example, the camera 118 captures a high-speed scan of the large surface. Based on the scan, the system can identify defects so as to define large-scale identification. Based on the large-scale identification, the tactile sensor 117 can perform high-resolution defect measurement, so as to define an automatic visual and tactile inspection system capable of quantifying micron-scale defects on arbitrarily large parts. The automatic inspection system can thus perform ‘global’ machine vision operations and local tactile sensing operations. For example, after a coarse scanning and evaluation of a given component surface from machine vision, the robot 104 can control the tactile sensor 117 to touch portions of the surface to detect and measure the defects to support manufacturing decision making. For example, a part with a shallow scratch might be remanufactured or recycled, while a part with a deep dent might be abandoned. Such an integration of vision, tactile, and robotic motion planning technologies can enable efficient and high-quality digitization and inspection of arbitrary large surfaces.

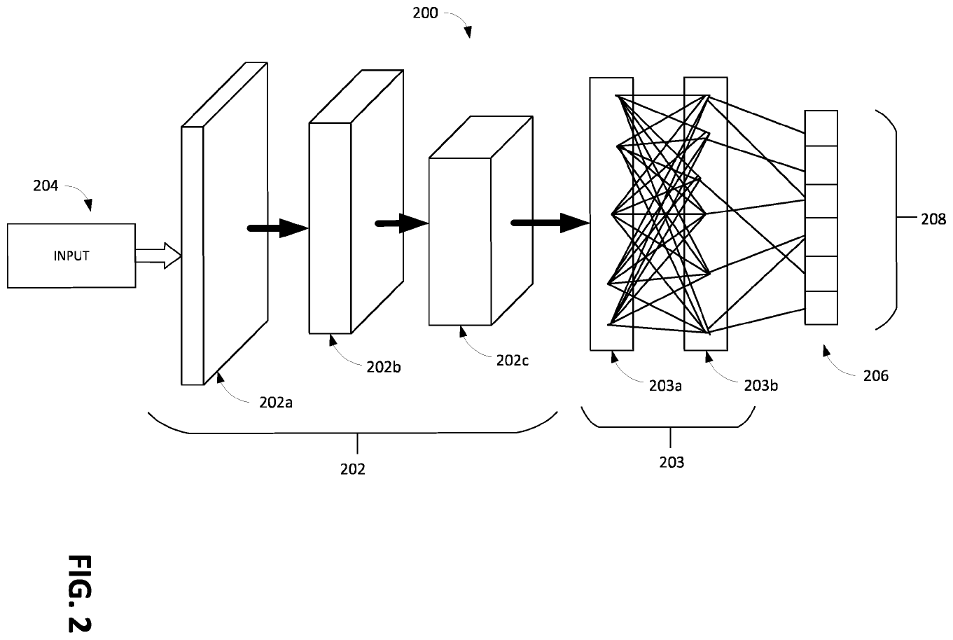

Referring also to FIG. 2, a computing system, for instance the system 102, can define one or more systems or networks 200 that can be trained on a plurality of input images or input data 204. During vision-based defect detection, an RGB camera, for instance the camera 118, can scan a given surface for predicting defects. In an example, a Faster R-CNN (Faster Region-based Convolutional Neural Network) model with MobileNetv3 FPN backbone is pretrained on a Common Objects in Context (COCO) dataset. The last layers (e.g., backbone layers, regression layers, classification models) of the models can be fine-tuned after feature prediction. Thus, in some cases, the neural network model can predict multiple bounding boxes per image. Each bounding box can contain the coordinates of a rectangular region in the camera coordinate frame. Each bounding box can further indicate a defect class and confidence score for that class. In some examples, the neural network (vision detection) model is fully convolutional, and can be used with images of any size without resizing, at both training and testing times.

Referring again to FIG. 2, the input data 204 can include RBGD images of objects or components, for instance images of metallic surfaces having various defects. During training of the networks, the network can generate an output map or output 206 that can define bounding box predictions related to potential defects. The network 300 can define an adversarial variational autoencoder (AVAE) system, for instance a convolutional AVAE. The example neural network 200 includes a plurality of layers, for instance an input layer 202a configured to receive data, an output layer 203b configured to generate class or output scores associated with the data or portions of the data. For example, the output layer 303b can be configured to determine anomaly or defect scores, singularity scores, or planar scores. The neural network 200 further includes a plurality of intermediate layers connected between the input layer 202a and the output layer 203b. In particular, in some cases, the intermediate layers and the input layer 202a can define a plurality of convolutional layers 202. The intermediate layers can further include one or more fully connected layers 203. The convolutional layers 202 can include the input layer 202a configured to receive training and test data, such as annotated depth images. In some cases, training data that the input layer 202a receives includes synthetic data of arbitrary components. Synthetic data can refer to training data that has been generated to render components with different defects. The convolutional layers 202 can further include a final convolutional or last feature layer 202c, and one or more intermediate or second convolutional layers 202b disposed between the input layer 202a and the final convolutional layer 202c. It will be understood that the illustrated model 200 is simplified for purposes of example. In particular, for example, models may include any number of layers as desired, in particular any number of intermediate layers, and all such models are contemplated as being within the scope of this disclosure.

The fully connected layers 203, which can include a first layer 203a and a second or output layer 203b, include connections between layers that are fully connected. For example, a neuron in the first layer 203a may communicate its output to every neuron in the second layer 203b, such that each neuron in the second layer 203b will receive input from every neuron in the first layer 203a. It will again be understood that the model is simplified for purposes of explanation, and that the model 200 is not limited to the number of illustrated fully connected layers 203. In contrast to the fully connected layers, the convolutional layers 202 may be locally connected, such that, for example, the neurons in the intermediate layer 202b might be connected to a limited number of neurons in the final convolutional layer 202c. The convolutional layers 202 can also be configured to share connections strengths associated with the strength of each neuron.

Still referring to FIG. 2, the input layer 202a can be configured to receive inputs 204, for instance images of the surface 119 captured by the camera 118, and the output layer 203b can be configured to return an output 206. The output 206 can include one or more classifications or scores associated with the input 204. For example, the output 206 can include an output vector that indicates a plurality of scores 208 associated with various portions, for instance pixels, of the corresponding input 204. Thus, the output layer 203b can be configured to generate scores 208 associated with the image 204, in particular associated with pixels of the image 204, thereby generating bounding boxes associated with locations on the surface 107 depicted in the image 204. The bounding boxes can define regions of interest (ROI) that represent areas of the surface 107 for which network generated defect scores that are above a threshold. Thus, the ROI can be represented by bounding boxes that indicate areas on the surface 107 where the system 102 has identified a defect.

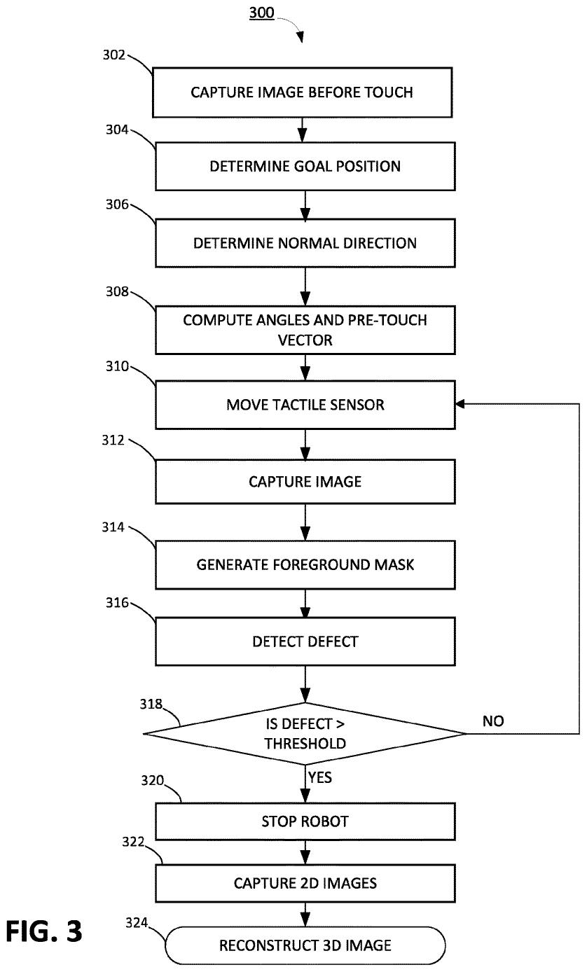

Referring now to FIG. 3, after the bounding boxes (ROI) are generated, the system 102 can perform an automated tactile inspection that can include tactile inspection and feedback control operations 300. The tactile inspection can be performed at the locations on the surface 107 identified by the bounding boxes as defining a defect. The system 102, for instance the robot 104, can control the tactile sensor 117, so as to generate images for which the quality can be measured quantitatively. It is recognized herein that performing an automated tactile inspection with the tactile sensor 117 is a contact-rich task. It is further recognized herein that the robotic system 102 can become highly rigid when the sensor 117 touches the surface of the part or component to apply proper contact force. For example, a small change in the position of the sensor 117 can trigger a significantly large change in the contact force. Furthermore, the contact force needs to be sufficient for the sensor 117 to capture tactile images of sufficient quality, but the tactile sensor can include, for instance be covered by, deformable and fragile materials that might break the tactile sensor 117. Thus, the system 102 can perform operations 300 to continuously check the captured tactile sensor measurements, and calculate setpoints of positions of the robot 104 for robot motion control.

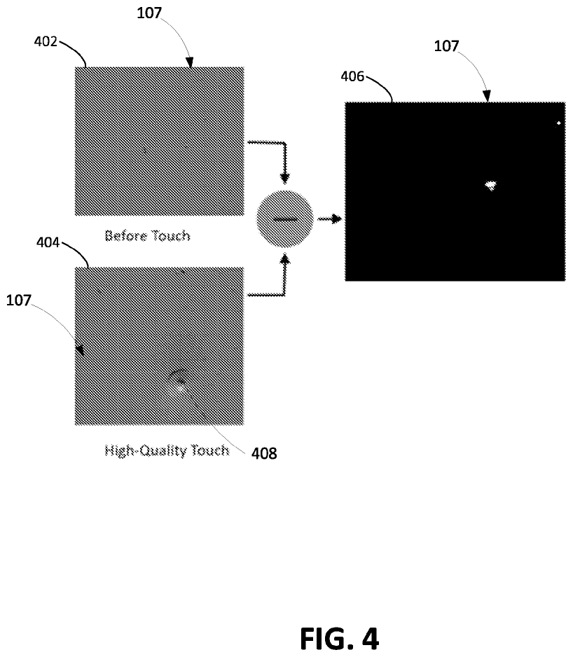

Referring also to FIG. 4, at 302, the system 102, for instance the RGBD camera 118, can capture a first or reference image 402 of the surface 107 while the tactile sensor 117 and/or RGBD camera 118 is positioned in a home position. The home position can define a position in which the RGBD camera 118 is positioned over the surface 107 such that an optimal compromise is achieved between the detect accuracy and the FOV (field of view). Based on the regions of interest determined during the visual inspection, for instance based on the regions of interest indicated in the output 208, the system 102 can determine a de-projected goal position or part registration, at 304. Determining the part registration can include automatically calculating the rigid-body transformations between the part local coordinate system to the robot coordinate system. Deprojection maps a 2D pixel location and depth on a stream's images from the RGBD camera 118 to a 3D point location within the stream's associated robot coordinate space. Thus, the de-projected goal position or part registration refers to the conversion of ROI information into a goal position in the coordinate system of the robot 104. The ROI information can be represented as bounding boxes on an image (or pixel frame) captured by the RGBD camera 118. In an example, the camera 118 defines an Intel RealSense 435F camera, though it will be understood the camera 118 can be implemented by various cameras configured to capture RGB images. The centroid of the ROI in the pixel frame can be represented as [pₓ, p_{y}], and the de-projected goal position can be represented as world coordinates [X, Y, Z] that can be computed as:

$$[ \begin{matrix}X \\ Y \\ Z\end{matrix} ] = [ \begin{matrix}R & t \\ 0 & 1\end{matrix} ] [ \begin{matrix}{f}_{x} & 0 & {c}_{x} \\ 0 & {f}_{y} & {c}_{y} \\ 0 & 0 & 1\end{matrix} ] [ \begin{matrix}{p}_{x} \\ {p}_{y} \\ {z}_{cam}\end{matrix} ] ,$$

where R is the rotation matrix; t is the transition vector; fₓ, f_{y} represent the camera focal length; cₓ, c_{y} represent the camera principal point offsets; and z_{cam} represents the camera scaling factor. In some cases, the camera intrinsic parameters can be obtained from Python scripts.

Still referring to FIGS. 3 and 4, at 306, the system 102 can estimate or determine the normal direction from the surface 107 at the ROIs. For example, the normal direction of the part surface 107 can be estimated from the point cloud data captured from the camera 118. In particular, for example, the system 102 can perform uniform sampling of point cloud points across the field of view (FOV) of the camera 118. A nonlinear 3D curve can be fitted to the sampled data, where the tangent direction of the fitted 3D curve can be used to calculate the surface normal direction. At 308, the determined or estimated surface normal direction can be converted into rotation angles [rₓ, r_{y}, r_{z}] in the coordinate frame of the robot 104. A pre-touch pose vector can be determined and defined as [X, Y, Z, rₓ, r_{y}, r_{z}]. The pre-touch pose vector can indicate the goal position and orientation, which defines the location and attacking angle of the tactile sensor 117 to touch the part surface 107. At 310, the system 102 moves the robot 104 along the determined normal direction toward the identified defect (represented by the ROI) on the surface 107. For example, referring in particular to FIG. 4, the system 102 can move the robot 104, in particular the end 119 of the tactile sensor 117 of the robot 104, toward a defect 408. At 310, the robot 104 can move the tactile sensor 117 so that the sensor 117 makes contact with the surface 107, in particular a location of the surface 107 represented by a bounding box. At 312, the sensor 117 can capture a first tactile image 404, for instance a set of tactile images 404, of the surface 107 while the sensor 117 touches the surface 107.

At 314, the system 102 can generate a foreground mask 406 by subtracting the first or reference image from the captured tactile images. In particular, for example, intermediate control points can be defined as the tactile sensor 117 makes contact and applies pressure on the surface 107. At each intermediate control point, the robot 104, in particular the embedded camera in the tactile sensor 117, can capture the tactile image 404 (at 312), which can define a newly acquired frame. Furthermore, at each intermediate control point, the system 102 can subtract each newly acquired frame (tactile image 404) from the reference image 402 captured before touch (pre-touch pose), so as to generate the foreground mask 406. The foreground mask can be used to detect and measure the defects to improve the accuracy and reduce the cycle time of the defect detection process by filtering the sensor noises efficiently.

At 316, the system 102 can perform contour detection and morphological operations (e.g., erosion and dilation) so as to detect when the tactile sensor 117 contacts and detects defects, for instance the defect 408. Furthermore, at 316, the system 102 can perform shape detection so as to determine a contour and class of the detected defect. For example, a circular connected component can denote a dent, and a line component can define a scratch.

Upon detecting a notable change, such as when the sensor 117 comes into contact with a defect, the identified contour of the change can be compared to a pre-established or predetermined threshold, at 318. The threshold value can be a tuning parameter. When the identified contour, in particular the identified contour defined by the defect, is greater than the predetermined threshold, the process proceeds to 320, where the movement of the robot 104, and thus the sensor 117, is halted at an image position. At 322, while the robot 104 and the tactile sensor 117 are in the image position, the camera of the tactile sensor can capture 2D images of the defect. At 324, based on the images captured at 322, a 3D image of the defect can be reconstructed for further analysis. By way of example, and without limitation, based on the 3D reconstruction, the type of defect can be determined or confirmed. Furthermore, various attributes of the defect, for instance size attributes such as minimum and maximum depths relative to the surface 107, can be determined. When the identified contour is less than the predetermined threshold, the process can return to 310, where the robot 104 continues to move along the normal direction and another tactile image 404 is captured, at 312.

Thus, as described herein, a vision and tactile guided robot system can include a robot defining a tactile sensor configured to contact and capture tactile images of a surface of a component. The system can further include a red green blue depth (RGBD) camera configured to capture images of the surface of the component. The system can also include one or more processors, and a memory storing instructions that, when executed by the one or more processors, cause the robot system to perform various operations. The operations can include controlling the tactile sensor so as to perform a tactile inspection of the surface, based at least in part on an RBGD image captured by the RGBD camera.

Based on the RBGD image, the system can determine a region of interest representative of an area on the surface in which a defect is defined. The system can capture a first image, with the tactile sensor, of the surface within the region of interest. The system can move the tactile sensor toward the area on the surface until the tactile sensor makes contact with the surface within the region of interest. The system can capture a second image, with the tactile sensor, of the surface within the region of interest. The system can generate a first foreground mask from the first image and the second image. Based on the first foreground mask, the system can determine whether the defect is greater than a predetermined threshold. When the defect is greater than the predetermined threshold, the system can stop the robot from moving further and capture two-dimensional (2D) images of the defect with the tactile sensor. Based on the 2D images, the system can reconstruct a three-dimensional (3D) image of the defect. Based on the 3D image of the defect, the system can determine one or more attributes corresponding to the defect. In some cases, the system can determine one or more size attributes of the defect, such as lengths, widths, and depths (e.g., minimum and maximum depths), defined by the defect. Thus, in an example, attributes include a maximum depth or a minimum depth defined by the defect as measured from the surface along the normal direction.

In an example aspect, when the defect is less than the predetermined threshold, the system can move the tactile sensor to a next intermediate point. At the next intermediate point, the system can capture a third image, with the tactile sensor of the surface within the region of interest. The system can generate a second foreground mask from the first image and the third image. Based on the second foreground mask, the system can determine whether the defect is greater than the predetermined threshold. Thus, the system can continue to capture images at different points, with the tactile sensor, until the defect is greater than the predetermined threshold. In another example aspect, based on the RBGD image, the system can determine a normal direction relative to the surface. The system can move the tactile sensor along the normal direction until it contacts the surface.

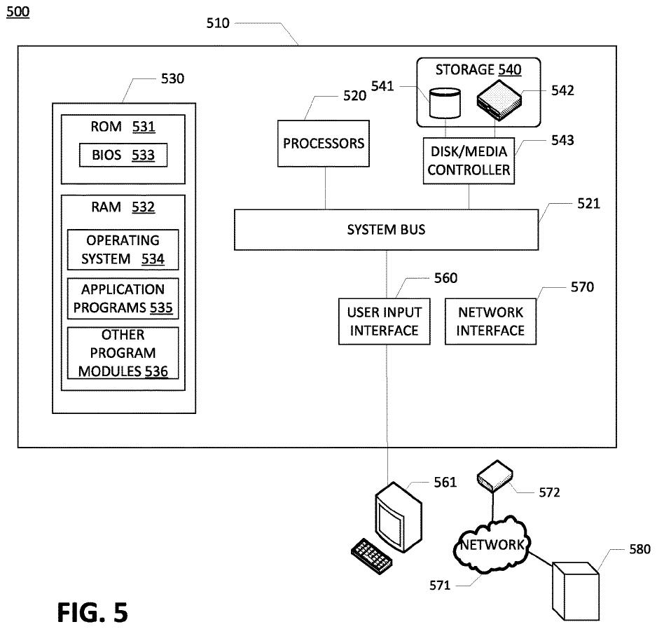

FIG. 5 illustrates an example of a computing environment within which embodiments of the present disclosure may be implemented. A computing environment 500 includes a computer system 510 that may include a communication mechanism such as a system bus 521 or other communication mechanism for communicating information within the computer system 510. The computer system 510 further includes one or more processors 520 coupled with the system bus 521 for processing the information.

The processors 520 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 520 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 521 may include at least one of a system bus, a memory bus, an address bus, or a message bus, and may permit exchange of information (e.g., data (including computer-executable code), signaling, etc.) between various components of the computer system 510. The system bus 521 may include, without limitation, a memory bus or a memory controller, a peripheral bus, an accelerated graphics port, and so forth. The system bus 521 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 5, the computer system 510 may also include a system memory 530 coupled to the system bus 521 for storing information and instructions to be executed by processors 520. The system memory 530 may include computer readable storage media in the form of volatile and/or nonvolatile memory, such as read only memory (ROM) 531 and/or random access memory (RAM) 532. The RAM 532 may include other dynamic storage device(s) (e.g., dynamic RAM, static RAM, and synchronous DRAM). The ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in the ROM 531. RAM 532 may contain data and/or program modules that are immediately accessible to and/or presently being operated on by the processors 520. System memory 530 may additionally include, for example, operating system 534, application programs 535, and other program modules 536. Application programs 535 may also include a user portal for development of the application program, allowing input parameters to be entered and modified as necessary.

The operating system 534 may be loaded into the memory 530 and may provide an interface between other application software executing on the computer system 510 and hardware resources of the computer system 510. More specifically, the operating system 534 may include a set of computer-executable instructions for managing hardware resources of the computer system 510 and for providing common services to other application programs (e.g., managing memory allocation among various application programs). In certain example embodiments, the operating system 534 may control execution of one or more of the program modules depicted as being stored in the data storage 540. The operating system 534 may include any operating system now known or which may be developed in the future including, but not limited to, any server operating system, any mainframe operating system, or any other proprietary or non-proprietary operating system.

The computer system 510 may also include a disk/media controller 543 coupled to the system bus 521 to control one or more storage devices for storing information and instructions, such as a magnetic hard disk 541 and/or a removable media drive 542 (e.g., floppy disk drive, compact disc drive, tape drive, flash drive, and/or solid state drive). Storage devices 540 may be added to the computer system 510 using an appropriate device interface (e.g., a small computer system interface (SCSI), integrated device electronics (IDE), Universal Serial Bus (USB), or FireWire). Storage devices 541, 542 may be external to the computer system 510.

The computer system 510 may perform a portion or all of the processing steps of embodiments of the invention in response to the processors 520 executing one or more sequences of one or more instructions contained in a memory, such as the system memory 530. Such instructions may be read into the system memory 530 from another computer readable medium of storage 540, such as the magnetic hard disk 541 or the removable media drive 542. The magnetic hard disk 541 (or solid state drive) and/or removable media drive 542 may contain one or more data stores and data files used by embodiments of the present disclosure. The data store 540 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any medium that participates in providing instructions to the processors 520 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 541 or removable media drive 542. Non-limiting examples of volatile media include dynamic memory, such as system memory 530. Non-limiting examples of transmission media include coaxial cables, copper wire, and fiber optics, including the wires that make up the system bus 521. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 500 may further include the computer system 510 operating in a networked environment using logical connections to one or more remote computers, such as remote computing device 580. The network interface 570 may enable communication, for example, with other remote devices 580 or systems and/or the storage devices 541, 542 via the network 571. Remote computing device 580 may be a personal computer (laptop or desktop), a mobile device, a server, a router, a network PC, a peer device or other common network node, and typically includes many or all of the elements described above relative to computer system 510. When used in a networking environment, computer system 510 may include modem 572 for establishing communications over a network 571, such as the Internet. Modem 572 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing device 580). The network 571 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 571.

It should be appreciated that the program modules, applications, computer-executable instructions, code, or the like depicted in FIG. 5 as being stored in the system memory 530 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 510, the remote device 580, and/or hosted on other computing device(s) accessible via one or more of the network(s) 571, may be provided to support functionality provided by the program modules, applications, or computer-executable code depicted in FIG. 5 and/or additional or alternate functionality. Further, functionality may be modularized differently such that processing described as being supported collectively by the collection of program modules depicted in FIG. 5 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 5 may be implemented, at least partially, in hardware and/or firmware across any number of devices.

It should further be appreciated that the computer system 510 may include alternate and/or additional hardware, software, or firmware components beyond those described or depicted without departing from the scope of the disclosure. More particularly, it should be appreciated that software, firmware, or hardware components depicted as forming part of the computer system 510 are merely illustrative and that some components may not be present or additional components may be provided in various embodiments. While various illustrative program modules have been depicted and described as software modules stored in system memory 530, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A vision and tactile guided robot system comprising:
a robot defining a tactile sensor configured to contact a surface of a component and capture tactile images of the surface of the component;
a red green blue depth (RGBD) camera configured to capture images of the surface of the component;
one or more processors; and
a memory storing instructions that, when executed by the one or more processors, cause the robot system to:
control the tactile sensor so as to perform a tactile inspection of the surface, based at least in part on an RBGD image captured by the RGBD camera.

2. The robot system as recited in claim 1, the memory further storing instructions that, when executed by the one or more processers further cause the robot system to:
based on the RBGD image, determine a region of interest representative of an area on the surface in which a defect is defined;
capture a first image, with the tactile sensor, of the surface within the region of interest;
move the tactile sensor toward the area on the surface;
capture a second image, with the tactile sensor, of the surface within the region of interest;
generate a first foreground mask from the first image and the second image;
based on the first foreground mask, determine whether the defect is greater than a predetermined threshold;
when the defect is greater than the predetermined threshold, stop the robot from moving further and capture two-dimensional (2D) images of the defect with the tactile sensor; and
based on the 2D images, reconstruct a three-dimensional (3D) image of the defect.

3. The robot system as recited in claim 2, the memory further storing instructions that, when executed by the one or more processers further cause the robot system to:
when the defect is less than the predetermined threshold, move the tactile sensor to a next intermediate point; and
at the next intermediate point, capture a third image, with the tactile sensor of the surface within the region of interest.

4. The robot system as recited in claim 3, the memory further storing instructions that, when executed by the one or more processers further cause the robot system to:
generate a second foreground mask from the first image and the third image; and
based on the second foreground mask, determine whether the defect is greater than the predetermined threshold.

5. The robot system as recited in claim 4, the memory further storing instructions that, when executed by the one or more processors further cause the robot system to:
continue to capture images at different points, with the tactile sensor, until the defect is greater than the predetermined threshold.

6. The robot system as recited in claim 2, the memory further storing instructions that, when executed by the one or more processers further cause the robot system to:
based on the RBGD image, determine a normal direction relative to the surface; and
move the tactile sensor along the normal direction until it contacts the surface.

7. The robot system as recited in claim 2, the memory further storing instructions that, when executed by the one or more processers further cause the robot system to:
based on the 3D image of the defect, determine one or more attributes corresponding to the defect.

8. The robot system as recited in claim 7, wherein the one or more attributes include a maximum depth or a minimum depth defined by the defect as measured from the surface along the normal direction.

9. A method performed by a vision and tactile guided robot system comprising a robot, a tactile sensor that defines an end effector of the robot, and a red green blue depth (RGBD) camera, the method comprising:
capturing, by the RGBD camera, an RGBD image of a surface of the component;
moving the tactile sensor, by the robot, to a position in contact with the surface of the component; and
controlling the tactile sensor so as to perform a tactile inspection of the surface, based at least in part on the RGBD image captured by the RGBD camera.

10. The method as recited in claim 9, the method further comprising:
based on the RBGD image, determining a region of interest representative of an area on the surface in which a defect is defined;
capturing a first image, with the tactile sensor, of the surface within the region of interest;
capturing a second image, with the tactile sensor, of the surface within the region of interest;
generating a first foreground mask from the first image and the second image;
based on the first foreground mask, determining whether the defect is greater than a predetermined threshold;
when the defect is greater than the predetermined threshold, stopping the robot from moving further and capturing two-dimensional (2D) images of the defect with the tactile sensor; and
based on the 2D images, reconstructing a three-dimensional (3D) image of the defect.

11. The method as recited in claim 10, the method further comprising:
when the defect is less than the predetermined threshold, moving the tactile sensor to a next intermediate point; and
at the next intermediate point, capturing a third image, with the tactile sensor of the surface, within the region of interest.

12. The method as recited in claim 11, the method further comprising:
generating a second foreground mask from the first image and the third image; and
based on the second foreground mask, determining whether the defect is greater than the predetermined threshold.

13. The method as recited in claim 14, the method further comprising:
continuing to capture images at different points, with the tactile sensor, until the defect is greater than the predetermined threshold.

14. The method as recited in claim 10, the method further comprising:
based on the RBGD image, determining a normal direction relative to the surface; and
moving the tactile sensor along the normal direction until it contacts the surface.

15. The method as recited in claim 9, the method further comprising:
based on the 3D image of the defect, determining one or more attributes corresponding to the defect.
